(19) United States
(12) Patent Application Publication
(10) Pub. No.: US 2025/0294419 A1
(43) Pub. Date: Sep. 18, 2025

(54) METHODS FOR CROSS-BASE STATION CELL CONFIGURATION

(71) Applicant: BEIJING XIAOMI MOBILE SOFTWARE CO., LTD., Beijing (CN)

(72) Inventors: Yumin WU, Beijing (CN); Yi XIONG, Beijing (CN)

(73) Assignee: BEIJING XIAOMI MOBILE SOFTWARE CO., LTD., Beijing (CN)

(21) Appl. No.: 18/860,415

(22) PCT Filed: Apr. 29, 2022
(86) PCT No.: PCT/CN2022/090790

§ 371 Date: Oct. 25, 2024

(51) Int. Cl. H04W 36/08; H04W 48/08; H04W 72/231; H04W 76/20

(52) U.S. Cl. CPC H04W 36/08; H04W 48/08; H04W 72/231; H04W 76/20

(57) ABSTRACT

A method for configuring a cross-base station cell is performed by a master node (MN). The method includes: determining at least one of an activation state or a type of a candidate cell, or at least one of an activation state or a type of a candidate cell group by communicating with a secondary node (SN) corresponding to the MN; and configuring at least one of the activation state or the type of the candidate cell for a terminal, or at least one of the activation state or the type of the candidate cell group for a terminal.

### CROSS-REFERENCE TO RELATED APPLICATION

This application is the U.S. National Stage Application of International Application No. PCT/CN2022/090790, filed on Apr. 29, 2022, the entire disclosure of which is incorporated herein by reference for all purposes.

### TECHNICAL FIELD

The present disclosure relates to a field of communication technology, and specifically to a method and an apparatus for configuring a cross-base station cell.

### BACKGROUND

In the related art, a network-side device can provide a pre-configured cell or cell group for selecting a cell group or cell, and network-side nodes correspond to the cell group in a dual-connectivity (DC) architecture. Meanwhile, a network-side base station may adopt a centralized unit (CU)-distributed unit (DU) architecture. However, there is no effective means of activating cells or cell groups between nodes.

### SUMMARY

According to a first aspect of the present disclosure, a method for configuring a cross-base station cell is performed by a master node (MN). The method includes: determining at least one of an activation state or a type of a candidate cell, or at least one of an activation state or a type of a candidate cell group by communicating with an SN corresponding to the MN; and configuring at least one of the activation state or the type of the candidate cell for a terminal, or at least one of the activation state or the type of the candidate cell group for a terminal.

According to a second aspect of the present disclosure, another method for configuring a cross-base station cell is performed by an SN. The method includes: determining at least one of an activation state or a type of a candidate cell, or at least one of an activation state or a type of a candidate cell group by communicating with a master node (MN) corresponding to the SN; and configuring at least one of the activation state or the type of the candidate cell for a terminal, or at least one of the activation state or the type of the candidate cell group for a terminal.

According to a third aspect of the present disclosure, another method for configuring a cross-base station cell is performed by a terminal. The method includes: acquiring a candidate cell or a candidate cell group configured by an MN, or a candidate cell or a candidate cell group configured by an SN; and acquiring at least one of an activation state or a type of the candidate cell or the candidate cell group configured by the MN, or at least one of an activation state or a type of the candidate cell or the candidate cell group configured by the SN.

### BRIEF DESCRIPTION OF THE DRAWINGS

In order to clearly illustrate the technical solutions in the embodiments or background of the disclosure, the drawings required to be used in the embodiments or background of the disclosure are briefly described below.

FIG. 1 is an architecture diagram of a communication system according to embodiments of the disclosure.

FIG. 2 is a flowchart of a method for configuring a cross-base station cell according to embodiments of the disclosure.

FIG. 3 is a flowchart of a method for configuring a cross-base station cell according to embodiments of the disclosure.

FIG. 4 is a flowchart of a method for configuring a cross-base station cell according to embodiments of the disclosure.

FIG. 5 is a structure diagram of a communication apparatus according to embodiments of the disclosure.

FIG. 6 is a structure diagram of another communication device according to embodiments of the disclosure.

FIG. 7 is a structure diagram of a chip according to embodiments of the disclosure.

### DETAILED DESCRIPTION

The terms mentioned in the disclosure are firstly introduced for easy understanding.

### 1. Downlink Control Information (DCI)

DCI is carried by a physical downlink control channel (PDCCH) and may include uplink and downlink resource allocation, hybrid automatic repeat request (HARQ) information, power control, etc. The PDCCH is a physical channel used to carry downlink scheduling information.

### 2. Dual Connectivity (DC) Architecture

In the 5G communication system, the DC architecture is adopted, which includes two cell groups: a master cell group (MCG), the MCG corresponding to a network-side master node (MN); and a secondary cell group (SCG), the SCG corresponding to a network-side secondary node (SN). The MCG includes one primary cell (PCell) and at least one secondary cell (Scell). The SCG includes one primary secondary cell (PSCell) and one or more Scells. PCell and PSCell are collectively referred to as a special cell (SpCell).

### 3. CU-DU Architecture

In the 5G communication system, a base station may include one CU and at least one DU, in which a radio interface transmission protocol stack entity corresponding to the CU includes: a radio resource control (RRC) and a packet data convergence protocol (PDCP).

The PDCP corresponding to the DU includes a radio link control (RLC), a medium access control (MAC), and a physical layer.

In order to better understand a method for configuring a cross-base station cell in embodiments of the disclosure, the communication system applicable to the embodiments of the disclosure is firstly described.

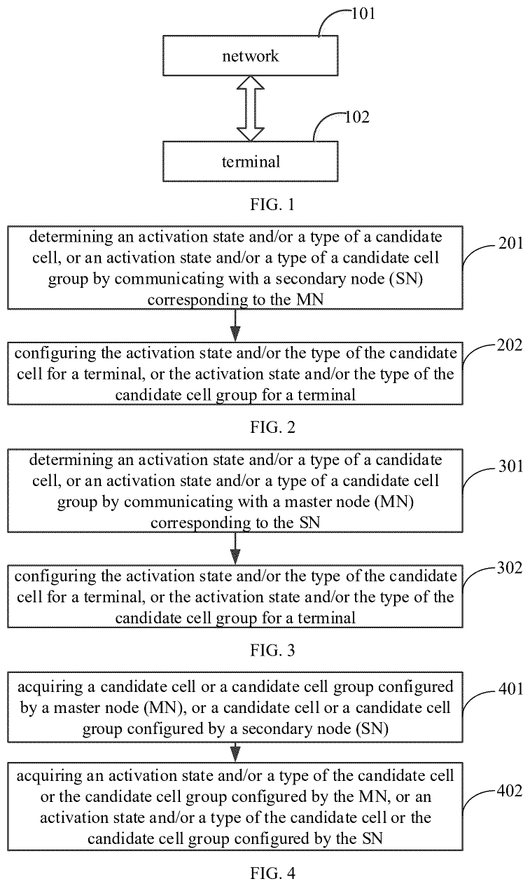

With respect to FIG. 1, FIG. 1 is an architecture diagram of a communication system according to embodiments of the disclosure. The communication system may include, but is not limited to, one network device and one terminal. The number and shape of the devices shown in FIG. 1 are for example only and do not constitute a limitation of embodiments of the disclosure. In practical applications, two or more network devices and two or more terminals may be included. The communication system illustrated in FIG. 1 includes a network device 101 and a terminal 102 as an example.

It should be noted that the technical solutions in embodiments of the disclosure can be applied to various communication systems, for example, a long term evolution (LTE) system, a 5th generation (5G) mobile communication system, a 5G new radio (NR) system, or other new mobile communication systems in the future. It should also be noted that a side link in embodiments of the disclosure can also be called a sidelink or a direct link.

The network device 101 in embodiments of the disclosure is an entity on the network side for transmitting or receiving signals. For example, the network device 101 can be an evolved NodeB (eNB), a transmission reception point (TRP), or a next generation NodeB (gNB) in the NR system, a base station in other future mobile communication systems, or an access node in wireless fidelity (WiFi) systems. The embodiments of the disclosure do not limit the specific technology and the specific device form used by the network device. The network device in embodiments of the disclosure includes a CU and a DU, in which the CU can also be called a control unit. The structure of CU-DU can be used to separate protocol layers of the network device, for example, a base station, so that some of the functions of the protocol layers are centrally controlled by the CU, and the remaining part or all of the functions of the protocol layers are distributed in the DU, which is centrally controlled by the CU.

The terminal 102 in embodiments of the disclosure is an entity on the user side for receiving or transmitting signals, such as a mobile phone. The terminal can also be called a user equipment (UE), a mobile station (MS), a mobile terminal (MT), etc. The terminal can be a car, a smart car, a mobile phone, a wearable device, and a Pad, with communication function, a computer with wireless transceiving functions, a virtual reality (VR) terminal, an augmented reality (AR) terminal, a wireless terminal in a industrial control, a wireless terminal in a self-driving, a wireless terminal in remote medical surgery, a wireless terminal in a smart grid, a wireless terminal in a transportation safety, a wireless terminal in a smart city, a wireless terminal in a smart home, etc. The embodiments of the disclosure do not limit the specific technology and the specific device form used by the terminal.

In the current NR system, the network side provides a preconfigured cell or cell group for the terminal to selectively activate a cell or a cell group. To enable the communication between the network side and terminals, it is needed that all nodes on the network side have the same understanding on configuration of the cell (or cell group) activated by terminals. When the terminal is configured with a DC and/or the network side adopts the CU-DU-separated network architecture, there is a lack of means to activate or deactivate the preconfigured cell or cell group across nodes, thus reducing the communication efficiency and wasting communication resources.

It may be understood that the communication system in embodiments of the disclosure is to more clearly explain the technical solutions of embodiments of the disclosure, and does not constitute a limitation on the technical solutions in embodiments of the disclosure. Those skilled in the art know that with the evolution of the system architecture and the emergence of new service scenarios, the technical solutions according to embodiments of the disclosure are equally applicable to similar technical problems.

The method and apparatus for configuring cross-base station cell in embodiments of the disclosure are introduced in detail in combination with the attached drawings.

With respect to FIG. 2, FIG. 2 is a flowchart of a method for configuring a cross-base station cell according to embodiments of the disclosure. The method is applicable to the MN. As illustrated in FIG. 2, the method includes, but is not limited to, the following blocks 201-202.

At 201, an activation state and/or a type of a candidate cell, or an activation state and/or a type of a candidate cell group are determined by communicating with an SN corresponding to the MN.

In the embodiments of the disclosure, the MN or SN in the network-side device firstly configures a plurality of candidate cells or candidate cell groups for the terminal, and the MN indicates the candidate cells or candidate cell groups corresponding to the terminal by transmitting a cell configuration message to the terminal. According to the needs under different scenarios, the MN needs to change the activation state and/or the type of the candidate cell, or the activation state and/or the type of the candidate cell group. To achieve the consistency between the MN and the SN in understanding the activation state and/or the type of the candidate cell or the activation state and/or the type of candidate cell group, the MN communicates with the SN to determine the activation state and/or the type of the candidate cell, or the activation state and/or the type of the candidate cell group. The MN communicating with the SN to determine the activation state and/or the type of the candidate cell or the activation state and/or the type of the candidate cell group can either be that the MN determines the activation state and/or the type of the candidate cell, or the activation state and/or the type of the candidate cell group and indicates them to the SN, or that the SN determines the activation state and/or the type of the candidate cell, or the activation state and/or the type of the candidate cell group and indicates them to the MN, or that the MN communicates with the SN to negotiate the activation state and/or the type of candidate cell, or the activation state and/or the type of the candidate cell group.

At 202, the activation state and/or the type of the candidate cell is configured for a terminal, or the activation state and/or the type of the candidate cell group is configured for a terminal.

In the embodiments of the disclosure, after determining the activation state and/or the type of the candidate cell, or the activation state and/or the type of the candidate cell group by negotiating with the SN, the MN transmits a message to the terminal and notifies the terminal of the activation state and/or the type of the candidate cell or the activation state and/or the type of the candidate cell group, in order to achieve the consistency when the terminal and the network-side device understand the activation state and/or the type of candidate cell or the activation state and/or the type of the candidate cell group.

In the embodiments of the disclosure, by acquiring the configuration determined after the communication between the MN and the SN, the configuration of the activation state and/or the type of the candidate cell or the candidate cell group across nodes is achieved, which is conducive to improving the communication efficiency and avoiding the resource waste.

In an alternative implementation, determining the activation state and/or the type of the candidate cell, or the activation state and/or the type of the candidate cell group by communicating with the SN corresponding to the MN includes at least one of: transmitting a first request message to the SN, or receiving a second request message from the SN. The first request message or the second request message includes indication information, and the indication information is configured to perform at least one of: requesting or indicating a change in the activation state and/or the type of the candidate cell, or the activation state and/or the type of the candidate cell group in the SN or a SCG; requesting or indicating a change in the activation state and/or the type of the candidate cell, or the activation state and/or the type of the candidate cell group in the MN or a MCG; changing the activation state and/or the type of the candidate cell, or the activation state and/or the type of the candidate cell group in the SN or a SCG; or changing the activation state and/or the type of the candidate cell, or the activation state and/or the type of the candidate cell group in the MN or the MCG.

In the embodiments of the disclosure, the MN corresponds to the MCG and the SN corresponds to the SCG. The MN actively communicates with the SN through the first request message to request or indicate the change in the activation state and/or the type of the candidate cell in the MN/MCG or the SN/SCG, or the change in the activation state and/or the type of the candidate cell group in the MN/MCG or the SN/SCG. The SN determines whether to receive the indication information in the first request message according to the first request message combined with the communication conditions and communication scenarios of the SN, and feeds back the first request message to the MN, so that the MN determines whether to change the activation state and/or the type of the candidate cell in the MN/MCG or the SN/SCG, or the activation state and/or the type of the candidate cell group in the MN/MCG or the SN/SCG. Or, the SN actively communicates with the MN through the second request message to request or indicate the change in the activation state and/or the type of the candidate cell in the SN/SCG, or the activation state and/or the type of the candidate cell group in the SN/SCG. The MN determines whether to receive the indication information in the second request message according to the second request message combined with the communication conditions and communication scenarios of the MN, and feeds back the second request message to the SN, so that the SN determines whether to change the activation state and/or the type of the candidate cell in the SN/SCG, or the activation state and/or the type of the candidate cell group in the SN/SCG. Or, the MN and the SN determines, by negotiating via the first request message and the second request message, the same activation state and/or the same type of the candidate cell, or the same activation state and/or the same type of the candidate cell group.

In an alternative implementation, a type of the indication information includes at least one of: an RRC; an MAC CE; DCI; a packet data convergence protocol control protocol data unit (PDCP Control PDU); or an interface signaling between base stations.

In an alternative implementation, there is an Xn interface between the MN and the SN, and an Xn interface signaling is transmitted via the Xn interface between the MN and the SN. The Xn interface signaling includes at least one of: an RRC container, an MAC CE container, a DCI container, or a PDCP Control PDU container.

In the embodiments of the disclosure, the Xn interface signaling is transmitted between the MN and the SN via the Xn interface between base stations, and the RRC container in the Xn interface signaling carries the content of the RRC message, or, the MAC CE container in the Xn interface signaling carries the content of the MAC CE message, or, the DCI container in the Xn interface signaling carries the content of the DCI message, or, the PDCP Control PDU container in the Xn interface signaling carries the content of the PDCP Control PDU.

In an alternative implementation, a type of the indication information is an RRC, an MAC CE, or a PDCP Control PDU, and the method further includes: transmitting first auxiliary indication information corresponding to the indication information to the SN.

In the embodiments of the disclosure, in case that the type of the indication information is at least one of the RRC, the MAC CE, or the PDCP Control PDU, the MN is needed to supplement the content of the indication information by providing the first auxiliary indication information for the SN via the Xn interface.

In an alternative implementation, the first auxiliary indication information includes at least one of: change information of the activation state and/or the type of the candidate cell, or change information of the activation state and/or the type of the candidate cell group; information of the activation state and/or the type of the candidate cell, or information of the activation state and/or the type of the candidate cell group; or information of a type of a radio interface signaling.

In embodiments of the disclosure, the first auxiliary indication information is configured to additionally indicate whether to change the activation state and/or the type of the candidate cell or the activation state and/or the type of the candidate cell group, or to indicate the activation state and/or the type of the candidate cell or the activation state and/or the type of the candidate cell group to support or assist the indication information.

The indication information needs to be transmitted to the terminal by a radio interface signaling, and the information of the type of the radio interface signaling in the first auxiliary indication information indicates the type of the radio interface signaling corresponding to the indication information, so as to indicate the method in which the indication information is transmitted to the terminal.

In an alternative implementation, the indication information is an interface signaling between base stations, and the method further includes: transmitting second auxiliary indication information corresponding to the indication information to the SN.

In the embodiments of the disclosure, in case that the type of the indication information is the interface signaling between base stations, the MN is needed to supplement the content of the indication information by providing the second auxiliary indication information for the SN via the Xn interface.

In an alternative implementation, the second auxiliary indication information includes information of a type of a radio interface signaling.

In an alternative implementation, the information of the type of the radio interface signaling includes at least one of: an RRC; an MAC CE; DCI; or a PDCP Control PDU.

Alternatively, in case that the type of the indication information is the RRC, the MAC CE, or the PDCP Control PDU, the type of the radio interface signaling in the first auxiliary indication is the same as the type of the indication information.

In a possible embodiment, in case that the type of the indication information is the RRC, the type of the radio interface signaling is the RRC, that is, the indication information is transmitted to the terminal via an RRC message.

In a possible embodiment, in case that the type of the indication information is the MAC CE, the type of the radio interface signaling is the MAC CE, that is, the indication information is transmitted to the terminal via an MAC CE message.

In a possible embodiment, in case that the type of the indication information is the DCI, the type of the radio interface signaling is the DCI, that is, the indication information is transmitted to the terminal via a DCI message.

In a possible embodiment, in case that the type of the indication information is the PDCP Control PDU, the type of the radio interface signaling is the PDCP Control PDU, that is, the indication information is transmitted to the terminal via a PDCP Control PDU message.

In an alternative implementation, the information of the type of the radio interface signaling is the RRC, and the first auxiliary indication information or the second auxiliary indication information further includes at least one of radio interface signaling transmission modes: an MCG signaling radio bearer (SRB); an SCG SRB; an MN-anchored split SRB; or an SN-anchored split SRB.

In an alternative implementation, a type of the indication information is the MAC CE or the DCI, the method further includes: requesting the indication information by a CU in the MN transmitting the first request message to a DU in the MN; and generating, by the DU in the MN, the MAC CE or the DCI corresponding to the indication information and transmitting the MAC CE or the DCI to the CU in the MN.

In the embodiments of the disclosure, the CU and the DU in the MN negotiate with each other by transmitting the first request message so that the CU and the DU in the MN achieve the consistency in understanding the activation state and/or the type of the candidate cell or the activation state and/or the type of the candidate cell group. The CU transmits the first request message to the DU so that the DU generates the MAC CE or the DCI corresponding to the indication information and feed back the MAC CE or the DCI to the CU.

In an alternative implementation, a type of the indication information is the MAC CE or the DCI, the method further includes: requesting the indication information by a DU in the MN transmitting the first request message to a CU in the MN; and generating, by the DU in the MN, the MAC CE or the DCI corresponding to the indication information and transmitting the MAC CE or the DCI to the CU in the MN.

In the embodiments of the disclosure, the DU in the MN transmits the first request message to the CU, generates the MAC CE or the DCI corresponding to the indication information and feed back the MAC CE or the DCI to the CU.

In an alternative implementation, the method further includes: receiving a first feedback message transmitted by the SN, in which the first feedback message indicates acceptance, partial acceptance, or rejection of the first request message.

In the embodiments of the disclosure, after receiving the first request message transmitted by the MN, the SN decides to accept, partially accept or reject the indication information in the first request message, generates and transmits the first feedback message to the MN. The MN acquires the decision of the SN according to the first feedback message.

In an alternative implementation, the method further includes: after the MN receives the first feedback message transmitted by the SN, in case that the first feedback message indicates acceptance or partial acceptance of the first request message and the indication information needs to be transmitted to the terminal via the MCG, transmitting by the MN the indication information to the terminal via the MCG.

In an alternative implementation, the method further includes: transmitting a second feedback message to the SN, in which the second feedback message indicates acceptance, partial acceptance, or rejection of the second request message.

In the embodiments of the disclosure, after receiving the second request message transmitted by the SN, the MN decides to accept, partially accept or reject the indication information in the second request message, generates and transmits the second feedback message to the SN. The SN acquires the decision of SN according to the second feedback message.

In an alternative implementation, the method further includes: in case that the MN decides to accept or partially accept the indication information in the second request message, and the indication information needs to be transmitted to the terminal via the MCG, the MN transmits the indication information to the terminal via the MCG.

In an alternative implementation, the activation state includes: activation or deactivation.

In an alternative implementation, a type of the candidate cell includes at least one of: a PCell; a PSCell; a SpCell; a SCell; a MCG SCell; or a SCG SCell.

In an alternative implementation, a type of the candidate cell group includes at least one of: an MCG; or an SCG.

With respect to FIG. 3, FIG. 3 is a flowchart of a method for configuring a cross-base station cell according to embodiments of the disclosure. The method is applicable to the SN. As illustrated in FIG. 3, the method includes, but is not limited to, the following blocks 301-302.

At 301, an activation state and/or a type of a candidate cell, or an activation state and/or a type of a candidate cell group are determined by communicating with an MN corresponding to the SN;

In the embodiments of the disclosure, the MN or SN in the network-side device firstly configures a plurality of candidate cells or candidate cell groups for the terminal, and the SN indicates the candidate cells or candidate cell groups corresponding to the terminal by transmitting a cell configuration message to the terminal. According to the needs under different scenarios, the SN needs to change the activation state and/or the type of the candidate cell, or the activation state and/or the type of the candidate cell group. To achieve the consistency between the MN and the SN in understanding the activation state and/or the type of the candidate cell or the activation state and/or the type of the candidate cell group, the MN communicates with the SN to determine the activation state and/or the type of the candidate cell, or the activation state and/or the type of the candidate cell group. The MN communicating with the SN to determine the activation state and/or the type of the candidate cell or the activation state and/or the type of the candidate cell group can either be that the MN determines the activation state and/or the type of the candidate cell or the activation state and/or the type of the candidate cell group and indicates them to the SN, or that the SN determines the activation state and/or the type of the candidate cell or the activation state and/or the type of the candidate cell group and indicates them to the MN, or that the MN communicates with the SN to negotiate the activation state and/or the type of the candidate cell or the activation state and/or the type of the candidate cell group.

At 302, the activation state and/or the type of the candidate cell is configured for a terminal, or the activation state and/or the type of the candidate cell group is configured for a terminal.

In the embodiments of the disclosure, after determining the activation state and/or the type of candidate cell or the activation state and/or the type of the candidate cell group by communicating with the MN, the SN transmits a message to the terminal and notifies the terminal of the activation state and/or the type of the candidate cell or the activation state and/or the type of the candidate cell group, in order to achieve the consistency when the terminal and the network- side device understand the activation state and/or the type of candidate cell or the activation state and/or the type of the candidate cell group.

In the embodiments of the disclosure, by acquiring the configuration determined after the communication between the MN and the SN, the configuration of the activation state and/or the type of the candidate cell or the candidate cell group across nodes is achieved, which is conducive to improving the communication efficiency and avoiding the resource waste.

In an alternative implementation, determining the activation state and/or the type of the candidate cell, or the activation state and/or the type of the candidate cell group by communicating with the MN corresponding to the SN includes at least one of: transmitting a second request message to the MN, and receiving a first request message from the MN. The first request message or the second request message includes indication information, and the indication information is configured to perform at least one of: changing the activation state and/or the type of the candidate cell, or the activation state and/or the type of the candidate cell group in the SN or an SCG; or changing the activation state and/or the type of the candidate cell, or the activation state and/or the type of the candidate cell group in the MN or an MCG; or requesting or indicating a change in the activation state and/or the type of the candidate cell, or the activation state and/or the type of the candidate cell group in the SN or an SCG.

In the embodiments of the disclosure, the MN corresponds to the MCG and the SN to the SCG. The SN actively communicates with the MN through the second request message to request or indicate the change in the activation state and/or the type of the candidate cell in the SN/SCG, or the change in the activation state and/or the type of the candidate cell group in the SN/SCG. The MN determines whether to receive the indication information in the second request message according to the second request message combined with the communication conditions and communication scenarios of the MN, and feeds back the second request message to the SN, so that the SN determines whether to change the activation state and/or the type of the candidate cell, or the activation state and/or the type of the candidate cell group in the SN or the SCG. Or, the MN actively communicates with the SN through the first request message to request or indicate the change in the activation state and/or the type of the candidate cell in the MN/MCG or the SN/SCG, or the activation state and/or the type of the candidate cell group in the MN/MCG or the SN/SCG. The SN determines whether to receive the indication information in the first request message according to the first request message combined with the communication conditions and communication scenarios of the SN, and feeds back the first request message to the MN, so that the MN determines whether to change the activation state and/or the type of the candidate cell, or the activation state and/or the type of the candidate cell group in the MN/MCG or the SN/SCG. Or, the MN and the SN determines, by negotiating via the first request message and the second request message, the same activation state and/or the same type of the candidate cell, or the same activation state and/or the same type of the candidate cell group.

In an alternative implementation, a type of the indication information includes at least one of: an RRC; an MAC CE; DCI; or a PDCP Control PDU.

In an alternative implementation, there is an Xn interface between the MN and the SN, and an Xn interface signaling is transmitted via the Xn interface between the MN and the SN, the Xn interface signaling includes at least one of: an RRC container, an MAC CE container, a DCI container, or a PDCP Control PDU container.

In the embodiments of the disclosure, the Xn interface signaling is transmitted between the MN and the SN via the Xn interface between base stations, and the RRC container in the Xn interface signaling carries the content of the RRC message, or, the MAC CE container in the Xn interface signaling carries the content of the MAC CE message, or, the DCI container in the Xn interface signaling carries the content of the DCI message, or, the PDCP Control PDU container in the Xn interface signaling carries the content of the PDCP Control PDU.

In an alternative implementation, a type of the indication information is an RRC, an MAC CE, or a PDCP Control PDU, and the method further includes: transmitting third auxiliary indication information corresponding to the indication information to the MN.

In the embodiments of the disclosure, in case that the type of the indication information is the RRC, the MAC CE, or the PDCP Control PDU, the SN is needed to supplement the content of the indication information by providing the first auxiliary indication information for the MN via the Xn interface.

In an alternative implementation, the third auxiliary indication information includes at least one of: change information of the activation state and/or the type of the candidate cell, or change information of the activation state and/or the type of the candidate cell group; information of the activation state and/or the type of the candidate cell, or information of the activation state and/or the type of the candidate cell group; or information of a type of a radio interface signaling.

In embodiments of the disclosure, the third auxiliary indication information is configured to additionally indicate whether to change the activation state and/or the type of the candidate cell or the activation state and/or the type of the candidate cell group, or to indicate the activation state and/or the type of the candidate cell or the activation state and/or the type of the candidate cell group to support or assist the indication information.

The indication information needs to be transmitted to the terminal by a radio interface signaling, and the information of the type of the radio interface signaling in the third auxiliary indication information indicates the type of the radio interface signaling corresponding to the indication information to indicate the method in which the indication information is transmitted to the terminal.

In an alternative implementation, the indication information is an interface signaling between base stations, and the method further includes: transmitting fourth auxiliary indication information corresponding to the indication information to the MN.

In the embodiments of the disclosure, in case that the type of the indication information is the interface signaling between base stations, the SN is needed to supplement the content of the indication information by providing the fourth auxiliary indication information for the MN via the Xn interface.

In an alternative implementation, the fourth auxiliary indication information includes information of a type of a radio interface signaling.

In an alternative implementation, the information of the type of the radio interface signaling includes at least one of: an RRC; an MAC CE; DCI; or a PDCP Control PDU.

Alternatively, in case that the type of the indication information is the RRC, the MAC CE, or the PDCP Control PDU, the type of the radio interface signaling in the first auxiliary indication is the same as the type of the indication information.

In a possible embodiment, in case that the type of the indication information is the RRC, the type of the radio interface signaling is the RRC, that is, the indication information is transmitted to the terminal via an RRC message.

In a possible embodiment, in case that the type of the indication information is the MAC CE, the type of the radio interface signaling is the MAC CE, that is, the indication information is transmitted to the terminal via an MAC CE message.

In a possible embodiment, when the type of the indication information is the DCI, the type of the radio interface signaling is the DCI, that is, the indication information is transmitted to the terminal via a DCI message.

In a possible embodiment, when the type of the indication information is the PDCP Control PDU, the type of the radio interface signaling is the PDCP Control PDU, that is, the indication information is transmitted to the terminal via a PDCP Control PDU message.

In an alternative implementation, the information of the type of the radio interface signaling is an RRC, and the third auxiliary indication information or the fourth auxiliary indication information further includes at least one of radio interface signaling transmission modes: an MCG signaling radio bearer (SRB); an SCG SRB; an MN-anchored split SRB; or an SN-anchored split SRB.

In an alternative implementation, a type of the indication information is the MAC CE or the DCI, the method further includes: requesting the indication information by a CU in the SN transmitting the second request message to a DU in the SN; and generating, by the DU in the SN, the MAC CE or the DCI corresponding to the indication information and transmitting the MAC CE or the DCI to the CU in the SN.

In the embodiments of the disclosure, the CU and the DU in the SN negotiate with each other by transmitting the first request message so that the CU and the DU in the SN achieve the consistency in understanding the activation state and/or the type of the candidate cell or the activation state and/or the type of the candidate cell group. The CU transmits the first request message to the DU so that the DU generates the MAC CE or the DCI corresponding to the indication information and feed back the MAC CE or the DCI to the CU.

In an alternative implementation, a type of the indication information is the MAC CE or the DCI, the method further includes: requesting the indication information by a DU in the SN transmitting the second request message to a CU in the MN; and generating, by the DU in the SN, the MAC CE or the DCI corresponding to the indication information and transmitting the MAC CE or the DCI to the CU in the SN.

In the embodiments of the disclosure, the DU in the SN transmits the first request message to the CU, generates the MAC CE or the DCI corresponding to the indication information and feed back the MAC CE or the DCI to the CU.

In an alternative implementation, the method further includes: receiving a second feedback message from the MN, in which the second feedback message indicates acceptance, partial acceptance, or rejection of the second request message.

In the embodiments of the disclosure, after receiving the second request message transmitted by the SN, the MN decides to accept, partially accept or reject the indication information in the second request message, generates and transmits the second feedback message to the SN. The SN acquires the decision of the SN according to the second feedback message.

In an alternative implementation, the method further includes: after the SN receives the first feedback message transmitted by the MN, in case that the first feedback message indicates acceptance or partial acceptance of the first request message and the indication information needs to be transmitted to the terminal via the SCG, transmitting by the SN the indication information to the terminal via the SCG.

In an alternative implementation, the method further includes: transmitting a first feedback message to the MN, in which the first feedback message indicates acceptance, partial acceptance, or rejection of the first request message.

In the embodiments of the disclosure, after receiving the first request message transmitted by the MN, the SN decides to accept, partially accept or reject the indication information in the first request message, generates and transmits the first feedback message to the MN. The MN acquires the decision of SN according to the first feedback message.

In an alternative implementation, the method further includes: in case that the SN decides to accept or partially accept the indication information in the first request message, and the indication information needs to be transmitted to the terminal via the SCG, transmitting by the SN, the indication information to the terminal via the SCG.

In an alternative implementation, the method further includes: in case that the first request message is not transmitted via the SCG under the SN, being unable to not reject the first request message by the SN.

In an alternative implementation, the activation state includes: activation or deactivation.

In an alternative implementation, a type of the candidate cell includes at least one of: a PCell; a PSCell; a SpCell; a SCell; a MCG SCell; or a SCG SCell.

In an alternative implementation, a type of the candidate cell group includes at least one of: an MCG; or an SCG.

With respect to FIG. 4, FIG. 4 is a flowchart of a method for configuring a cross-base station cell according to embodiments of the disclosure. The method is applicable to the terminal. As illustrated in FIG. 4, the method includes, but is not limited to, the following blocks 401-402.

At 401, a candidate cell or a candidate cell group configured by an MN is acquired, or a candidate cell or a candidate cell group configured by an SN is acquired.

In the embodiments of the disclosure, the MN or the SN in the network-side device firstly configures a plurality of candidate cells or candidate cell groups for the terminal, and the MN or the SN indicates the candidate cells or candidate cell groups corresponding to the terminal by transmitting a cell configuration message to the terminal.

At 402, an activation state and/or a type of the candidate cell or the candidate cell group configured by the MN is acquired, or an activation state and/or a type of the candidate cell or the candidate cell group configured by the SN is acquired.

According to the needs under different scenarios, the MN or the SN needs to change the activation state and/or the type of the candidate cell, or the activation state and/or the type of the candidate cell group. To achieve the consistency between the MN and the SN in understanding the activation state and/or the type of the candidate cell or the activation state and/or the type of candidate cell group, the MN communicates with the SN to determine the activation state and/or the type of the candidate cell, or the activation state and/or the type of the candidate cell group. The MN and the SN transmit a message to the terminal to notify the terminal of the activation state and/or the type of candidate cell or the activation state and/or the type of the candidate cell group, in order to achieve the consistency when the terminal and the network-side device understand the activation state and/or the type of candidate cell or the activation state and/or the type of the candidate cell group.

In this technical solution, by acquiring the configuration determined after the communication between the MN and the SN, the configuration of the activation state and/or the type of the candidate cell or the candidate cell group across nodes is achieved, which is conducive to improving the communication efficiency and avoiding the resource waste.

In an alternative implementation, acquiring the candidate cell or the candidate cell group configured by the MN, or the candidate cell or the candidate cell group configured by the SN further includes: configuring the candidate cell or the candidate cell group according to a predetermined protocol.

In embodiments of the disclosure, the MN or the SN on the network side configures the activation state and/or the type of the candidate cell for a terminal, or the activation state and/or the type of the candidate cell group for a terminal, by transmitting the configuration information. In a possible embodiment, the MN, the SN, and the terminal make an agreement on the candidate cell or the candidate cell group through the pre-configured protocol.

In an alternative implementation, acquiring the activation state and/or the type of the candidate cell or the candidate cell group configured by the MN, or the activation state and/or the type of the candidate cell or the candidate cell group configured by the SN includes: determining the activation state and/or the type of the candidate cell, or the activation state and/or the type of the candidate cell group by acquiring a radio interface signaling transmitted by the MN or the SN.

In a possible embodiment, the MN, the SN, and the terminal make an agreement on the type of candidate cell or the type of the candidate cell group through the pre-configured protocol.

In an alternative implementation, the type of the radio interface signaling includes at least one of: an RRC; an MAC CE; DCI; or a PDCP Control PDU.

In an alternative implementation, the activation state includes: activation or deactivation.

In an alternative implementation, a type of the candidate cell includes at least one of: a PCell; a PSCell; a SpCell; a SCell; a MCG SCell; or a SCG SCell.

In an alternative implementation, a type of the candidate cell group includes at least one of: an MCG; or an SCG.

In the above embodiments of the disclosure, the methods in the embodiments of the disclosure are introduced respectively from the perspective of the network device and the terminal. In order to realize the functions of the methods in the above embodiments of the disclosure, the network device and the terminal may include a hardware structure, and a software module, so that the above functions are implemented in the form of the hardware structure, the software module, or the hardware structure plus the software module. One of these functions can be implemented in the form of the hardware structure, the software module, or the hardware structure plus the software module.

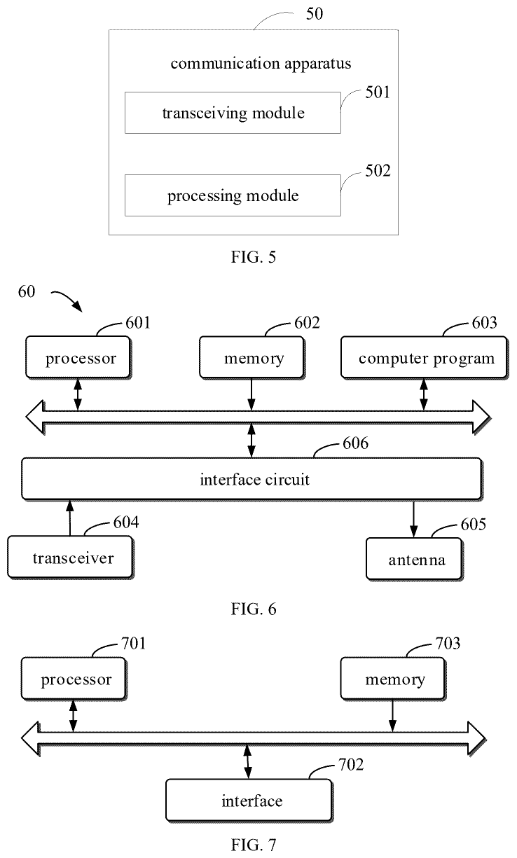

With respect to FIG. 5, FIG. 5 is a structure diagram of a communication apparatus 50 according to embodiments of the disclosure. The communication apparatus 50 illustrated in the FIG. 5 includes a transceiving module 501 and a processing module 502. The transceiving module includes a transmitting module and/or a receiving module. The transmitting module is configured to achieve the transmitting function, the receiving module is configured to achieve the receiving function, and the transceiving module 501 can achieve the transmitting function and/or receiving function.

The communication apparatus 50 can be a terminal (such as the terminal in the preceding embodiments of the method), an apparatus in the terminal, or a device being used in conjunction with the terminal. Or, the communication apparatus 50 can be a network device, an apparatus in the network device, or a device being used in conjunction with the network device.

The communication apparatus 50 is the MN in the network-side device and includes a first communication module and a first configuration module.

The first communication module is configured to determine an activation state and/or a type of a candidate cell, or an activation state and/or a type of a candidate cell group by communicating with a SN corresponding to the MN.

The first configuration module configures the activation state and/or the type of the candidate cell for a terminal, or the activation state and/or the type of the candidate cell group for a terminal.

The communication apparatus 50 is the SN in the network-side device and includes a second communication module and a second configuration module.

The second communication module is configured to determine an activation state and/or a type of a candidate cell, or an activation state and/or a type of a candidate cell group by communicating with an MN corresponding to the SN.

The second configuration module configures the activation state and/or the type of the candidate cell for a terminal, or the activation state and/or the type of the candidate cell group for a terminal.

The communication device 50 is the terminal and includes a first transceiving module and a second transceiving module.

The first transceiving module is configured to acquire a candidate cell or a candidate cell group configured by an MN, or a candidate cell or a candidate cell group configured by an SN.

The second transceiving module is configured to acquire an activation state and/or a type of the candidate cell or the candidate cell group configured by the MN, or an activation state and/or a type of the candidate cell or the candidate cell group configured by the SN.

With respect to FIG. 6, FIG. 6 is a structure diagram of another communication device 60 according to embodiments of the disclosure. The communication device 60 can be a network device, or a terminal (such as the terminal in the preceding method embodiments), or a chip, a chip system, a processor, etc. that supports the network device to implement the method, or a chip, a chip system, a processor, etc. that supports the terminal to implement the method. The device is configured to implement the method in the above method embodiments. For details, please refer to the descriptions in the above method embodiments.

The communication device 60 may include one or more processor 601. The processor 601 can be a general-purpose processor or a special-purpose processor. For example, it may be a baseband processor or a central processing unit. The baseband processor is configured to process communication protocols and communication data, and the central processor is configured to control communication devices (such as base stations, baseband chips, terminals, terminal chips, DU or CU, etc.) to execute computer programs and process computer program data.

Alternatively, the communication device 60 may also include one or more memory 602 on which a computer program 603 is stored. When the computer program 603 is executed by the processor 601, the communication device 60 performs the method in the above method embodiments. Alternatively, the memory 602 may also store data. The communication device 60 and the memory 602 can be set separately or integrated together.

Alternatively, the communication device 60 includes a transceiver 604 and an antenna 605. The transceiver 604 can be called a transceiving unit, a transceiving machine, or a transceiving circuit, etc., to implement the transceiving function. The transceiver 604 includes a receiver and a transmitter. The receiver can be called a receiver or a receiving circuit, etc., for realizing the receiving function; and the transmitter can be called a transmitter or a transmitting circuit, etc., to implement the transmitting function.

Alternatively, the communication device 60 includes one or more interface circuit 606. The interface circuit 606 is configured to receive a code instruction and transmit the code instruction to the processor 601. The code instruction is running on the processor 601 runs, the communication device 60 is caused to implement the method in the above embodiments.

When the communication device 60 is a terminal (such as the terminal in the above method embodiments), the processor 601 is configured to execute block 201 or block 202 in FIG. 2, or to perform block 301 or block 302 in FIG. 3.

When the communication device 60 is a network device, the transceiver 604 is configured to execute block 501 or block 502 in FIG. 5.

In an implementation, the processor 601 includes a transceiver for implementing the receiving and transmitting function. For example, the transceiver can be a transceiving circuit, or an interface, or an interface circuit. The transceiving circuits, interfaces, or interface circuits configured to perform the receiving and transmitting function may be separate or integrated together. The transceiving circuit, interface or interface circuit may be configured to read and write code/data, or the transceiving circuit, interface or interface circuit may be configured to transmit signals.

In an embodiment, the processor 601 stores a computer program 603. When the computer program 603 is running on the processor 601, the communication device 60 is caused to perform the method in the above embodiments. The computer program 603 may be solidified in the processor 601. In this way, the processor 601 may be implemented in hardware.

In an embodiment, the communication device 60 includes a circuit that can implement the transmitting or receiving or communicating function in the above method embodiments. The processors and transceivers in the disclosure can be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver can also be manufactured with various IC process technologies, such as a complementary metal oxide semiconductor (CMOS), nMetal-oxide-semiconductor (NMOS), a positive channel metal oxide semiconductor (PMOS), bipolar junction transistor (BJT), a bipolar CMOS (BiCMOS), silicon germanium (SiGe), gallium arsenide (GaAs), etc.

The communication device in the above embodiments may be a network device or a terminal (such as the terminal in the method embodiments), but the scope of the communication device in the disclosure is not limited to this, and the structure of the communication device may not be restricted by FIG. 6. The communication device can be a independent device or part of a larger device. For example, the communication device can be:
(1) an independent IC, or a chip, or a chip system or a subsystem;

(2) a collection including one or more IC, alternatively, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

For the case where the communication device can be a chip or a chip system, the schematic diagram of the chip structure shown in FIG. 7 can be an example. The chip in FIG. 7 includes the processor 701 and the interface 702. There may be one ore more processors, and there may be a plurality of interfaces 702.

For the case where the chip is configured to realize the functions of the terminal in the embodiments of the disclosure (such as the terminal in the above method embodiments), alternatively, the chip also includes a memory 703, which is configured to store necessary computer programs and data.

Those skilled in the art may also understand that the various illustrative logical blocks and steps listed in the embodiments of the disclosure may be implemented by electronic hardware, computer software, or their combination. Whether such a function is implemented in hardware or software depends on specific applications and design requirements of the overall system. Those skilled in the art may, for each specific application, use a variety of methods to achieve the above function, but such implementation shall not be regarded as going beyond the scope of the protection of the embodiments of the disclosure.

The embodiments of the disclosure also provide a system for configuring a cross-base station cell. The system includes a communication device as a terminal (such as the terminal in the above method embodiments) and a communication device as a network device in the above embodiments in FIG. 5. Alternatively, the system includes a communication device as a terminal (such as the terminal in the above method embodiments) and a communication device as a network device in the above embodiments in the above embodiments in FIG. 6.

The disclosure also provides a computer-readable storage medium on which instructions are stored. When the instruction is executed by a computer, the function of any of the above method embodiments is implemented.

The disclosure also provides a computer program product. When the computer program product is executed by a computer, the functions of any of the above method embodiments is implemented.

In the technical solutions according to the embodiments of the disclosure, by communicating with each other through a master node (MN) and a secondary node (SN), configuration of an activation state and/or a type of the candidate cell or the candidate cell group across nodes is achieved, which is conducive to improving a communication efficiency and avoiding a resource waste.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of embodiments of the disclosure, but also to indicate an order of precedence.

At least one in the present disclosure may also be described as one or more, and a plurality of may be two, three, four or more, which is not limited in the present disclosure. In embodiments of the present disclosure, for a kind of technical feature, technical features in the kind of technical feature are distinguished by “first”, “second”, “third”, “A”, “B”, “C” and “D”, and there is no order of precedence or magnitude between technical features described in “first”, “second”, “third”, “A”, “B”, “C” and “D”.

Corresponding relationships indicated by tables in the present disclosure may be configured or predefined. Values of information in the tables are only examples, and may be configured as other values, which are not limited in the disclosure. When the corresponding relationship between information and parameters is configured, it is not always necessary to configure all corresponding relationships indicated in tables. For example, in the tables of the present disclosure, corresponding relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the present disclosure, may be implemented by an electronic hardware or a combination of an electronic hardware and a computer software. Whether the functions are executed by the hardware or the software depends on a specific application and a design constraint of the technical solutions. Those skilled in the art may adopt different methods for each specific application to implement the described functions, but such implementation should not be considered as going beyond the scope of the present disclosure.

Those skilled in the art may clearly understand that, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be contained within the protection scope of the present disclosure. Therefore, the protection scope of the disclosure shall be subject to the protection scope of claims.

1. A method for configuring a cross-base station cell, performed by a master node (MN), comprising:
determining at least one of an activation state or a type of a candidate cell, or at least one of an activation state or a type of a candidate cell group by communicating with a secondary node (SN) corresponding to the MN; and
configuring at least one of the activation state or the type of the candidate cell for a terminal, or at least one of the activation state or the type of the candidate cell group for a terminal.

2. The method according to claim 1, wherein determining the at least one of the activation state or the type of the candidate cell, or the at least one of the activation state or the type of the candidate cell group by communicating with the SN corresponding to the MN comprises at least one of:
transmitting a first request message to the SN, or receiving a second request message from the SN;
wherein the first request message or the second request message comprises indication information, and the indication information is configured to perform at least one of following operations:
requesting or indicating a change in the at least one of the activation state or the type of the candidate cell, or the at least one of the activation state or the type of the candidate cell group in the SN or a secondary cell group (SCG);
requesting or indicating a change in the at least one of the activation state or the type of the candidate cell, or the at least one of the activation state or the type of the candidate cell group in the MN or a secondary cell group (MCG); or
changing the at least one of the activation state or the type of the candidate cell, or the at least one of the activation state or the type of the candidate cell group in the SN or the SCG.

3. The method according to claim 2, wherein a type of the indication information comprises at least one of: a radio resource control (RRC); a medium access control control element (MAC CE); downlink control information (DCI); a packet data convergence protocol control protocol data unit (PDCP Control PDU); or an interface signaling between base stations; or
wherein there is an Xn interface between the MN and the SN, and an Xn interface signaling is transmitted via the Xn interface between the MN and the SN, wherein the Xn interface signaling comprises at least one of following containers: an RRC container, an MAC CE container, a DCI container, or a PDCP Control PDU container.

4. (canceled)

5. The method according to claim 23, wherein a type of the indication information is the RRC. the MAC CE, or the PDCP Control PDU, and the method further comprises:
transmitting first auxiliary indication information corresponding to the indication information to the SN; or
wherein the indication information is the interface signaling between base stations, and the method further comprises: transmitting second auxiliary indication information corresponding to the indication information to the SN.

6. The method according to claim 5, wherein the first auxiliary indication information comprises at least one of following information:
change information of the activation state or the type of the candidate cell, or change information of the activation state or the type of the candidate cell group;
information of the activation state or the type of the candidate cell, or information of the activation state or the type of the candidate cell group; or
information of a type of a radio interface signaling; or
wherein the second auxiliary indication information comprises information of a type of a radio interface signaling, and the information of the type of the radio interface signaling comprises at least one of: an RRC; an MAC CE; DCI; or a PDCP Control PDU.

7-9. (canceled)

10. The method according to claim 96, wherein the information of the type of the radio interface signaling is an RRC, and the first auxiliary indication information or the second auxiliary indication information further comprises at least one of following radio interface signaling transmission modes:
an MCG signaling radio bearer (SRB);
an SCG signaling radio bearer (SRB);
an MN-anchored split SRB; or
an SN-anchored split SRB.

11. The method according to claim-2 3, wherein the type of the indication information is the MAC CE, or the DCI, and the method further comprises one of:
requesting the indication information by a centralized unit (CU) in the MN transmitting the first request message to a distributed unit (DU) in the MN; and
generating, by the DU in the MN, the MAC CE or the DCI corresponding to the indication information and transmitting the MAC CE or the DCI to the CU in the MN; or
requesting the indication information by a DU in the MN transmitting the first request message to a CU in the MN; and generating, by the DU in the MN, the MAC CE or the DCI corresponding to the indication information and transmitting the MAC CE or the DCI to the CU in the MN.

12. (canceled)

13. The method according to claim 2, further comprising:
receiving a first feedback message transmitted by the SN, wherein the first feedback message indicates acceptance, partial acceptance, or rejection of the first request message; or
transmitting a second feedback message to the SN, wherein the second feedback message indicates acceptance, partial acceptance, or rejection of the second request message.

14. (canceled)

15. The method according to claim 1, wherein
the activation state comprises: activation or deactivation;
wherein a type of the candidate cell comprises at least one of: a primary cell (PCell); a primary secondary cell (PSCell); a special cell (SpCell); a secondary cell (SCell); a master cell group (MCG) SCell; or a secondary cell group (SCG) SCell; or
wherein a type of the candidate cell group comprises at least one of a master cell group (MCG) or a secondary cell group (SCG).

16-17. (canceled)

18. A method for configuring a cross-base station cell, performed by a secondary node (SN), comprising:
determining at least one of an activation state or a type of a candidate cell, or at least one of an activation state or a type of a candidate cell group by communicating with a master node (MN) corresponding to the SN; and
configuring at least one of the activation state or the type of the candidate cell for a terminal, or at least one of the activation state or the type of the candidate cell group for a terminal.

19. The method according to claim 18, wherein determining the at least one of the activation state or the type of the candidate cell, or the activation state or the at least one of the type of the candidate cell group by communicating with the MN corresponding to the SN comprises at least one of:
transmitting a second request message to the MN, and receiving a first request message from the MN;
wherein the first request message or the second request message comprises indication information, and the indication information is configured to perform at least one of following operations:
changing the at least one of the activation state or the type of the candidate cell, or the at least one of the activation state or the type of the candidate cell group in the SN or a secondary cell group (SCG);
changing the at least one of the activation state or the type of the candidate cell, or the activation state or the type of the candidate cell group in the MN or a master cell group (MCG); or
requesting or indicating a change in the at least one of the activation state or the type of the candidate cell, or the at least one of the activation state or the type of the candidate cell group in the SN or a secondary cell group (SCG).

20. The method according to claim 19, wherein a type of the indication information comprises at least one of: a radio resource control (RRC); a medium access control control element (MAC CE); downlink control information (DCI); or a packet data convergence protocol control protocol data unit (PDCP Control PDU); or an interface signaling between base stations; or
wherein there is an Xn interface between the MN and the SN, and an Xn interface signaling is transmitted via the Xn interface between the MN and the SN, wherein the Xn interface signaling comprises at least one of following containers: an RRC container, an MAC CE container, a DCI container, or a PDCP Control PDU container.

21. (canceled)

22. The method according to claim 1920, wherein the indication information is the RRC, the MAC CE, or the PDCP Control PDU, and the method further comprises:
transmitting third auxiliary indication information corresponding to the indication information to the MN; or
wherein the indication information is the interface signaling between base stations, and the method further comprises: transmitting fourth auxiliary indication information corresponding to the indication information to the MN.

23. The method according to claim 22, wherein the third auxiliary indication information comprises at least one of following information:
change information of the at least one of the activation state or the type of the candidate cell, or change information of the at least one of the activation state or the type of the candidate cell group;
information of the at least one of the activation state or the type of the candidate cell, or information of the at least one of the activation state or the type of the candidate cell group; or
information of a type of a radio interface signaling;
wherein the fourth auxiliary indication information comprises information of a type of a radio interface signaling, and the information of the type of the radio interface signaling comprises at least one of: an RRC; an MAC CE; DCI; or a PDCP Control PDU.

24-26. (canceled)

27. The method according to claim 23, wherein the information of the type of the radio interface signaling is the RRC, and the third auxiliary indication information or the fourth auxiliary indication information further comprises at least one of following radio interface signaling transmission modes:
an MCG signaling radio bearer (SRB);
an SCG signaling radio bearer (SRB);
an MN-anchored split SRB; or
an SN-anchored split SRB.

28. The method according to claim 20, wherein a-the type of the indication information is the MAC CE or the DCI-a medium access control control element (MAC CE) or downlink control information (DCI), and the method further comprises one of following operations:
requesting the indication information by a centralized unit (CU) in the SN transmitting the second request message to a distributed unit (DU) in the SN; and
generating, by the DU in the SN, the MAC CE or the DCI corresponding to the indication information and transmitting the MAC CE or the DCI to the CU in the SN; or
requesting the indication information by a DU in the SN transmitting the second request message to a CU in the MN; and generating, by the DU in the SN, the MAC CE or the DCI corresponding to the indication information and transmitting the MAC CE or the DCI to the CU in the SN.

29. (canceled)

30. The method according to claim 19, further comprising at least one of following operations:
receiving a second feedback message from the MN, wherein the second feedback message indicates acceptance, partial acceptance, or rejection of the second request message;
transmitting a first feedback message to the MN, wherein the first feedback message indicates acceptance, partial acceptance, or rejection of the first request message; or
in response to determining that the first request message is not transmitted via the SCG under the SN, determining that the SN is unable to reject the first request message.

31-35. (canceled)

36. A method for configuring a cross-base station cell, performed by a terminal, comprising:
acquiring a candidate cell or a candidate cell group configured by a master node (MN), or a candidate cell or a candidate cell group configured by a secondary node (SN); and
acquiring at least one of an activation state or a type of the candidate cell or the candidate cell group configured by the MN, or at least one of an activation state or a type of the candidate cell or the candidate cell group configured by the SN.

37. The method according to claim 36, wherein acquiring the candidate cell or the candidate cell group configured by the MN, or the candidate cell or the candidate cell group configured by the SN further comprises:
configuring the candidate cell or the candidate cell group according to a predetermined protocol; or
wherein acquiring the at least one of the activation state or the type of the candidate cell or the candidate cell group configured by the MN, or the at least one of the activation state or the type of the candidate cell or the candidate cell group configured by the SN comprises: determining the at least one of the activation state or the type of the candidate cell, or the at least one of the activation state or the type of the candidate cell group by acquiring a radio interface signaling transmitted by the MN or the SN.

38-45. (canceled)

46. A communication device, comprising:
a processor and
a memory for storing a computer program, wherein when the computer program stored in the memory is executed by the processor, the communication device is caused to implement the method according to claim 36.

47-48. (canceled)
